(19) United States
(12) Patent Application Publication
(10) Pub. No.: US 2026/0348289 A1
(43) Pub. Date: Nov. 5, 2026

(54) ADDITIVE LAYER MANUFACTURING TURBINE VANES WITH INTEGRAL SPACERS

(71) Applicant: Rolls-Royce North American Technologies Inc., Indianapolis, IN (US)

(72) Inventors: Andrew M. Simonich, Indianapolis, IN (US); Michel S. Smallwood, Indianapolis, IN (US); Rex M. Little, Indianapolis, IN (US); Lawrence Langford, Indianapolis, IN (US)

(21) Appl. No.: 19/195,698

(22) Filed: Apr. 30, 2025

(51) Int. Cl. F01D 9/04; B33Y 10/00; B33Y 40/20; B33Y 80/00; F01D 11/00

(52) U.S. Cl. CPC F01D 9/041; B33Y 10/00; B33Y 40/20; B33Y 80/00; F01D 11/003; F05D 2230/10; F05D 2230/31; F05D 2240/80

(57) ABSTRACT

A method includes additively manufacturing an engine component assembly including first and second vane assemblies and a first spacer between the first and second vane assemblies such that the first and second vane assemblies and the first spacer are formed in a single fabrication operation. The additive manufacturing includes forming a first vane platform having a first side wall, forming a second vane platform having a second side wall facing the first side wall, and forming the first spacer between the first and second vane platforms of the first and second vane assemblies, the first spacer extending between and interconnecting the first and second side walls. The first spacer provides structural support for the engine component assembly at least during the additive manufacturing of the engine component assembly and during post-processing machining of the engine component assembly after the additive manufacturing.

### FIELD OF THE DISCLOSURE

The present disclosure relates generally to gas turbine engines, and in particular, to components of gas turbine engines that can be formed via additive layer manufacturing processes.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high-pressure air and is ignited. Products of the combustion reaction in the combustor are directed into the turbine where work is extracted by rows of rotating blades and non-rotating vanes to drive the compressor and, sometimes, an output shaft. Each blade and vane has an airfoil that interacts with gases as they pass through the engine.

Construction and assembly of gas turbine engine components can present many challenges due to the great complexity of the components and the assembly process of these components. Engine components should be manufactured with the utmost precision to ensure the engine is assembled as accurate to design as possible, to ensure smooth and safe operation of the engine, and to improve performance, among other things.

### SUMMARY

The present disclosure may comprise one or more of the following features and combinations thereof.

According to a first aspect of the present disclosure, a method includes additively manufacturing an engine component assembly of a gas turbine engine including a first vane assembly, a second vane assembly, and a first spacer between the first and second vane assemblies such that the first and second vane assemblies and the first spacer are formed in a single fabrication operation. The additive manufacturing of the first and second vane assemblies and the first spacer can include forming a first vane platform of the first vane assembly that extends circumferentially about a central axis of the gas turbine engine and a first vane extending radially away from the first vane platform and configured to interact with gases flowing through the gas turbine engine, the first vane platform having a first side wall, forming a second vane platform of the second vane assembly adjacent to the first vane platform that extends circumferentially about the central axis and a second vane extending radially away from the second vane platform and configured to interact with the gases, the second vane platform having a second side wall facing the first side wall, and forming the first spacer between the first and second vane platforms of the first and second vane assemblies, the first spacer extending between and interconnecting the first and second side walls, the first spacer provides structural support for the engine component assembly at least during the additive manufacturing of the engine component assembly and during post-processing machining of the engine component assembly after the additive manufacturing.

In some embodiments, the first spacer is removable such that the first spacer is configured to be removed from the engine component assembly after the additive manufacturing of the engine component assembly, and the first spacer is at least one of located so as be mechanically removable or formed of a material so as to chemically removable.

In some embodiments, the method further includes machining at least one surface of the engine component assembly so as to remove material from the at least one surface, and after machining the at least one surface, removing the first spacer from the engine component assembly.

In some embodiments, the first side wall is a first circumferentially-facing side wall of the first vane platform that faces in a first circumferential direction and the second side wall is a second circumferentially-facing side wall of the second vane platform that faces in a second circumferential direction opposite the first circumferential direction.

In some embodiments, the additive manufacturing of the first and second vane assemblies and the first spacer further includes forming a third vane platform of the first vane assembly that extends circumferentially about a central axis of the gas turbine engine radially spaced apart from the first vane platform, the first vane extending between and interconnecting the first and third vane platforms, the first and third vane platforms being radially outer and inner vane platforms of the first vane assembly, respectively, the third vane platform having a third side wall, forming a fourth vane platform of the second vane assembly that extends circumferentially about the central axis radially spaced apart from the second vane platform and adjacent to the third vane platform, the second vane extending between and interconnecting the second and fourth vane platforms, the second and fourth vane platforms being radially outer and inner vane platforms of the second vane assembly, respectively, the fourth vane platform having a fourth side wall, and forming a second spacer between the third and fourth vane platforms of the first and second vane assemblies, the second spacer extending between and interconnecting the third and fourth side walls.

In some embodiments, the method further includes additively manufacturing a full hoop vane ring including a plurality of the engine assemblies each including the first and second vane assemblies and the first and second spacers formed therebetween.

In some embodiments, the method further includes machining a plurality of surfaces of the plurality of the engine assemblies of the full hoop vane ring, and after machining the pluralities of surfaces, removing each first and second spacer from the plurality of engine assemblies such that each first and second vane assembly arranged about the full hoop vane ring is spaced apart from each other so as to allow for thermal expansion and contraction of the first and second vane assemblies when arranged in and during operation of the gas turbine engine.

In some embodiments, the additive manufacturing of the first and second vane assemblies and the first spacer further includes forming a first seal between the first and second vane platforms of the first and second vane assemblies, the first seal configured to block the gases flowing over the first and second vane assemblies from passing through a gap between the first and second vane assemblies.

In some embodiments, the first seal is radially spaced apart from the first spacer in a direction toward the central axis.

In some embodiments, the additive manufacturing of the first and second vane assemblies and the first spacer further includes forming a first groove having a first protrusion-receiving recess in the first side wall of the first vane platform, forming a second groove having a second protrusion-receiving recess in the second side wall of the second vane platform, forming the first seal to include a first projecting portion received in the first protrusion-receiving recess and a second projecting portion received in the second protrusion-receiving recess such that the first seal is interlocked within the first and second grooves

In some embodiments, the method further includes removing the first spacer so as to allow the gases flowing over the first and second vane assemblies to interact with the first seal.

According to a further aspect of the present disclosure, a method includes forming a first engine component of a gas turbine engine including a first side wall, forming a second engine component of the gas turbine engine arranged adjacent to the first engine component and including a second side wall facing the first side wall, forming a first spacer between the first and second engine components, the first spacer extending between and interconnecting the first and second side walls of the first and second engine components, machining at least one surface of the first and second engine components so as to remove material from the at least one surface, and after machining the at least one surface, removing the first spacer from between the first and second engine components.

In some embodiments, the first and second engine components and the first spacer are formed via additive manufacturing such that the first and second engine components and the first spacer are formed in a single fabrication operation.

In some embodiments, the first spacer is at least one of located so as be mechanically removable or formed of a material so as to chemically removable.

In some embodiments, the first engine component is a first vane assembly of the gas turbine engine and the second engine component is a second vane assembly, and the first side wall is located on a first vane platform of the first vane assembly and the second side wall is located on a second vane platform of the second vane assembly.

In some embodiments, the method further includes additively manufacturing a full hoop vane ring including a plurality of the first and second vane assemblies and a plurality of the first spacers formed therebetween.

In some embodiments, the additive manufacturing of the first and second vane assemblies and the first spacer further includes forming a first seal between the first and second vane platforms of the first and second vane assemblies, the first seal configured to block the gases flowing over the first and second vane assemblies from passing through a gap between the first and second vane assemblies, and the first seal is radially spaced apart from the first spacer in a direction toward the central axis.

According to a further aspect of the present disclosure, an engine component assembly for a gas turbine engine, the engine component assembly includes a first vane assembly of a gas turbine engine including a first vane platform that extends circumferentially about a central axis of the gas turbine engine and a first vane extending radially away from the first vane platform and configured to interact with gases flowing through the gas turbine engine, the first vane platform having a first side wall, a second vane assembly arranged adjacent to the first vane assembly and including a second vane platform that extends circumferentially about the and a second vane extending radially away from the second vane platform and configured to interact with gases flowing through the gas turbine engine, the second vane platform having a second side wall, and a first spacer arranged between the first and second vane platforms of the first and second vane assemblies, the first spacer extending between and interconnecting the first and second side walls.

In some embodiments, the first and second engine vane assemblies and the first spacer are formed via additive manufacturing such that the first and second vane assemblies and the first spacer are formed in a single fabrication operation, the first spacer provides structural support for the engine component assembly at least during the additive manufacturing of the first and second vane assemblies and during post-processing machining of the first and second vane assemblies after the additive manufacturing.

In some embodiments, the first spacer is removable such that the first spacer is configured to be removed from the first and second vane assemblies after the additive manufacturing of the first and second vane assemblies, the first spacer is at least one of located so as be mechanically removable or formed of a material so as to chemically removable, and the first and second vane assemblies are machinable such that material is configured to be removed from at least one surface of the first and second vane assemblies, and the first spacer is removable after machining of the at least one surface occurs.

In some embodiments, the engine component assembly further includes a first seal arranged between the first and second vane platforms of the first and second vane assemblies, the first seal configured to block the gases flowing over the first and second vane assemblies from passing through a gap between the first and second vane assemblies, and the first seal is radially spaced apart from the first spacer in a direction toward the central axis.

These and other features of the present disclosure will become more apparent from the following description of the illustrative embodiments.

### BRIEF DESCRIPTION OF THE DRAWINGS

FIG. 1 is a cutaway view of a gas turbine engine that includes a fan, a compressor, a combustor, and a turbine, the fan including a fan rotor configured to rotate about a central axis of the engine, and showing that the turbine can include an annular vane ring having multiple vane assemblies circumferentially adjacent to each other and at least one seal arranged between the assemblies, the annular vane ring being formed via additive layer manufacturing;

FIG. 2 is an axially-facing conceptual view of the annular vane ring of FIG. 1 after being formed via additive layer manufacturing, showing that each vane assembly includes outer and inner vane platforms and at least one vane extending therebetween, and showing that the vane assemblies are circumferentially spaced apart by spacers that can be removed after the vane ring has been formed via additive layer manufacturing and after machining of a surface or surfaces of the vane assemblies;

FIG. 3A is a front view of an annular vane ring of FIG. 1, showing the vane assemblies arranged circumferentially adjacent to each other in an annular fashion to create the annular vane ring, each vane assembly including two vanes extending between the inner vane platform and an outer vane platform, and showing the spacers having been removed from between the vane assemblies such that only the seals remain between the vane assemblies;

FIG. 3B is a radially-facing view of an exemplary additive manufacturing process of the annular vane ring of FIG. 3A, showing that the vane ring can be fabricated or built up in an axial direction;

FIG. 4 is a perspective view of a vane assembly of the annular ring of FIG. 3A, showing spacers formed on circumferentially-facing surfaces of the outer and inner platforms and seals of the outer and inner platforms removed to show grooves within which the seals are arranged;

FIG. 5 is a perspective view of a vane assembly of the annular ring of FIG. 4, showing the spacers formed on circumferentially-facing surfaces of the outer and inner platforms and the seals arranged in the grooves of the outer and inner platforms;

FIG. 6 is a magnified perspective view of the outer platform of the vane assembly of FIG. 5, showing the spacer formed in the circumferentially-facing surface of the outer platform and the seal arranged in the groove of the outer platform;

FIG. 7 is an axially-facing cross-sectional view of adjacent vane assemblies of the annular vane ring of FIG. 3A, showing the spacers and seals arranged between the vane assemblies after the vane ring has been formed;

FIG. 8 is an axially-facing cross-sectional view of adjacent vane assemblies of FIG. 7, showing outer and inner surfaces of the outer and inner platforms, respectively, as well as outer and inner surfaces of the outer and inner spacers, respectively, having been machined off;

FIG. 9 is a magnified perspective view of an outer platform of a vane assembly configured to be utilized in the annular vane ring of FIG. 1 according to a further aspect of the present disclosure, showing that the spacer formed in the circumferentially-facing surface of the outer platform can be formed as multiple cylindrical bodies;

FIG. 10 is an axially-facing cross-sectional view of adjacent vane assemblies configured to be utilized in the annular vane ring of FIG. 1 according to a further aspect of the present disclosure, showing that the spacers can be arranged at a different radial position as compared to the position shown in FIG. 7, in particular closer to the seals arranged between the vane assemblies;

FIG. 11 is a magnified perspective view of an outer platform of a vane assembly configured to be utilized in the annular vane ring of FIG. 1 according to a further aspect of the present disclosure, showing that multiple spacers can be formed in the circumferentially-facing surface of the outer platform including axially elongated spacers and multiple cylindrical spacers;

FIG. 12A is an axially-facing cross-sectional view of the adjacent vane assemblies of FIG. 11;

FIG. 12B is a magnified axially-facing cross-sectional view of one of the vane assemblies of FIG. 11;

FIG. 13A is a radially-facing cross-sectional view of an outer platform of a vane assembly configured to be utilized in the annular vane ring of FIG. 1 according to a further aspect of the present disclosure, showing that the circumferentially-facing side walls may be formed at an angle relative to the axial direction;

FIG. 13B is a radially-facing cross-sectional view of an outer platform of a vane assembly configured to be utilized in the annular vane ring of FIG. 1 according to a further aspect of the present disclosure, showing that the circumferentially-facing side walls may be formed as an S-shape;

FIG. 14A is a radially-facing cross-sectional view of an outer platform of a vane assembly configured to be utilized in the annular vane ring of FIG. 1 according to a further aspect of the present disclosure, showing that the spacer may be formed at an angle relative to the circumferentially-facing side walls as well as to the build platform;

FIG. 14B is a radially-facing cross-sectional view of an outer platform of a vane assembly configured to be utilized in the annular vane ring of FIG. 1 according to a further aspect of the present disclosure, showing that the spacer, formed as a cylindrical body, may be formed at an angle relative to the circumferentially-facing side walls as well as to the build platform; and

FIG. 14C is a radially-facing cross-sectional view of an outer platform of a vane assembly configured to be utilized in the annular vane ring of FIG. 1 according to a further aspect of the present disclosure, showing that the spacer may include a lower protruding support that can rest on the build platform and support the remainder of the spacer.

### DETAILED DESCRIPTION

For the purposes of promoting an understanding of the principles of the disclosure, reference will now be made to a number of illustrative embodiments illustrated in the drawings and specific language will be used to describe the same.

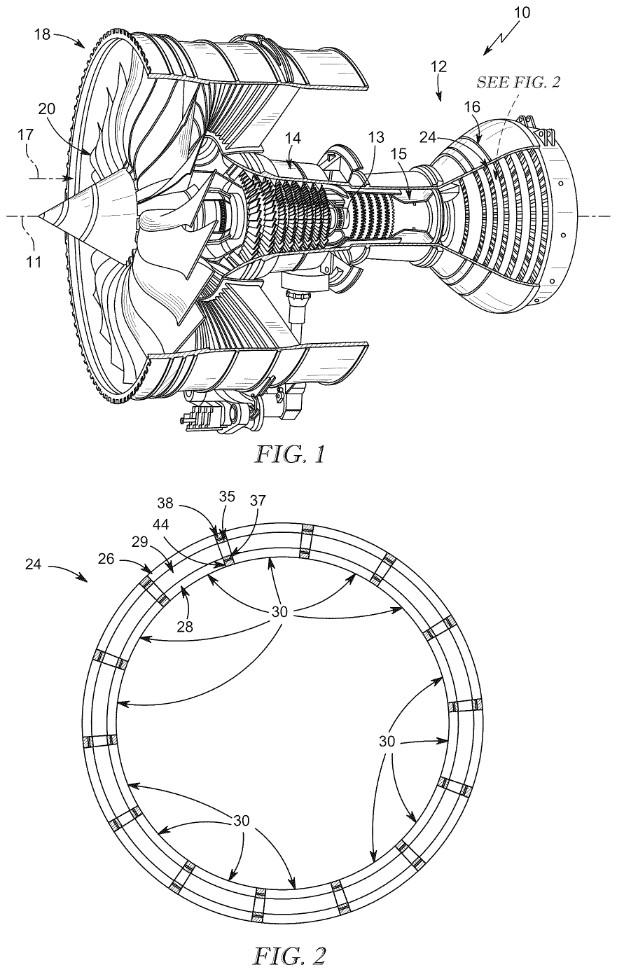

A gas turbine engine 10 in accordance with the present disclosure is shown in FIG. 1 and includes an engine core 12 and a fan 18 having a fan rotor 20 arranged upstream of the engine core 12. The engine core 12 is configured to compress and combust air 17 entering the gas turbine engine 10 to drive rotation of one or more shafts 13 about a rotation axis 11 of the gas turbine engine 10. The one or more shafts 13 interconnect the engine core 12 and the fan 18 to cause rotation of the fan rotor 20 and to provide thrust for the gas turbine engine 10.

The engine core 12 includes a compressor 14, a combustor 15, and a turbine 16. The compressor 14 includes one or more stages of rotating blades that compress air 17 entering the engine core 12 and produce pressurized air which is transferred downstream to the combustor 15. The combustor is configured to mix fuel with the pressurized air 17 and combust the fuel and pressurized air to produce combustion products which are transferred downstream to the turbine 16. The turbine 16 also includes one or more stages of rotating blades which are coupled to the one or more shafts 13 and are driven in rotation about the axis 11. Rotation of the one or more shafts 13 causes rotating components of the fan rotor 20 to rotate about the axis 11.

According to a first aspect of the present disclosure, turbine 16 can include an annular vane ring 24 arranged between stages of rotating blades of the turbine 16, the vane ring 24 being formed via additive layer manufacturing. By utilizing additive layer manufacturing to fabricate the vane ring 24, the vane ring 24 and its constituent components can be formed via a “single fabrication operation.” It is noted that references to additive layer manufacturing herein may also refer to “advanced manufacturing”.

A single fabrication operation may refer to, in some non-limiting examples, as the vane ring 24 and its components (which can include the vane assemblies 30, seals 35, 37, and spacers 38, 44 described herein) being formed as a single, monolithic component in which all components of the ring 24 are connected to each other during the initial fabrication process. After the initial fabrication and during post-processing, components that are intended to be separate when the vane ring 24 is implemented in the gas turbine engine 10, such as the vane assemblies 30, the seals 35, 37, and the spacers 38, 44, may be separated from each other. Specifically, for example, sacrificial standoffs can be arranged in the grooves 34A, 34B, 36A, 36B that support the seals 35, 37 during the fabrication process which may be removed so as to allow the seals 35, 37 to be suspended in the grooves 34A, 34B, 36A, 36B and allow for pressure-induced movement thereof during operation of the engine 10. The spacers 38, 44 are also formed integrally with the vane assemblies 30 during fabrication of the vane ring 24, and can be removed after the initial fabrication and/or after machining of surfaces or parts of the vane assemblies 30.

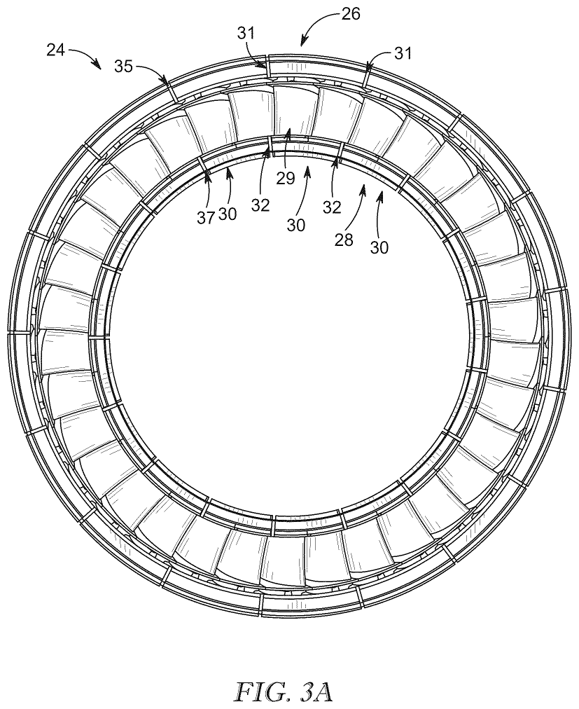

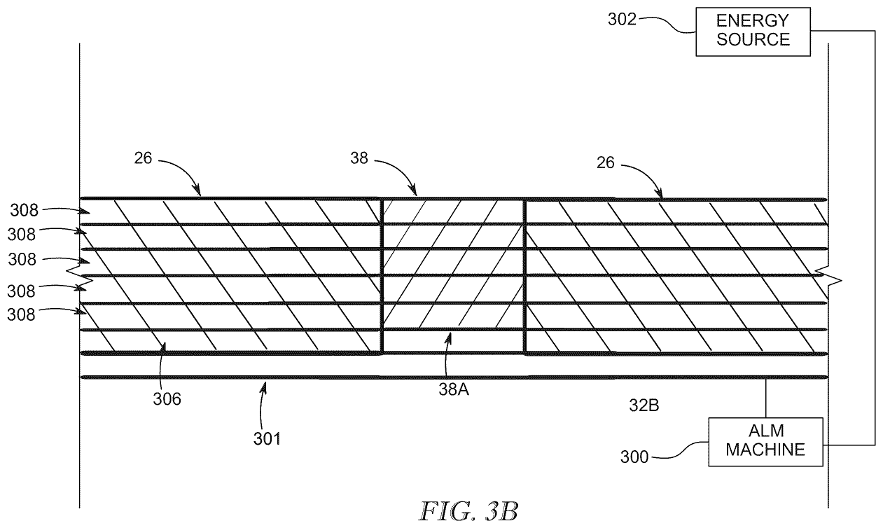

A single fabrication operation may also refer to, in other non-limiting examples, as the vane ring 24 and its components (which can include the vane assemblies 30 and seals 35, 37 described herein) being formed disconnected from each other, at least in some areas, during an uninterrupted, layer-by-layer fabrication process. For instance, in the exemplary fabrication steps shown in FIG. 3B, the layers 306, 308 can be formed without any type of standoffs formed in the grooves 34A, 34B, 36A, 36B so as to form the loose, separate components (i.e. the seals 35, 37 being suspended in the grooves 34A, 34B, 36A, 36B). The loose, separate components, such as the seals 35, 37, can be separated from each other and supported on each other via additive layer powder, utilized for the additive layer manufacturing fabrication, being arranged in the regions between these separate components.

In many gas turbine engines, vane rings are formed in sections or segmented vane assemblies that are arranged circumferentially adjacent to each other in an annular fashion to create the vane ring 24. In order to block gases flowing through the turbine 16 through circumferential gaps formed between the segmented vane assemblies, the vane ring 24 can include seals arranged between the vane assemblies. According to the present disclosure, the entire vane ring 24 and its components can be formed in a single fabrication operation via additive layer manufacturing, which can lead to accurate dimensioning of each component, consistent and uniform production of multiple vane rings 24, ease of assembly, and high sealing performance. In order to provide additional support for the adjacent assemblies during the fabrication process, as well as after during any type of post-processing that can include, for example, machining of surfaces or parts of the vane assemblies 30, the vane ring 24 can be formed with spacers 38, 44 between each vane assembly 30 that can be removed after the fabrication process.

Although reference is made to a vane ring 24 throughout the description, the present disclosure contemplates the application of the vane assemblies, spacers, and seals, and additive layer manufacturing of the same, as described herein, in other areas of the gas turbine engine 10. Accordingly, in some instances herein, the two adjacent components that include spacers and seals therebetween may be referred to as “vane assemblies” while in other instances, may be referred to as “engine components.” By way of non-limiting examples, such engine components may further include exhaust nozzles, cassette combustors, infrared suppressors, vane supports, combustor to vane transitions, tailcones and the like. It is noted that the descriptions and illustrations of the vane assemblies, spacers, and seals described herein are indicative of how such vane assemblies, spacers, and seals would be applied in these exemplary alternative engine components, namely the descriptions and illustrations of two adjacent components, at least one seal, and at least one spacer extending therebetween.

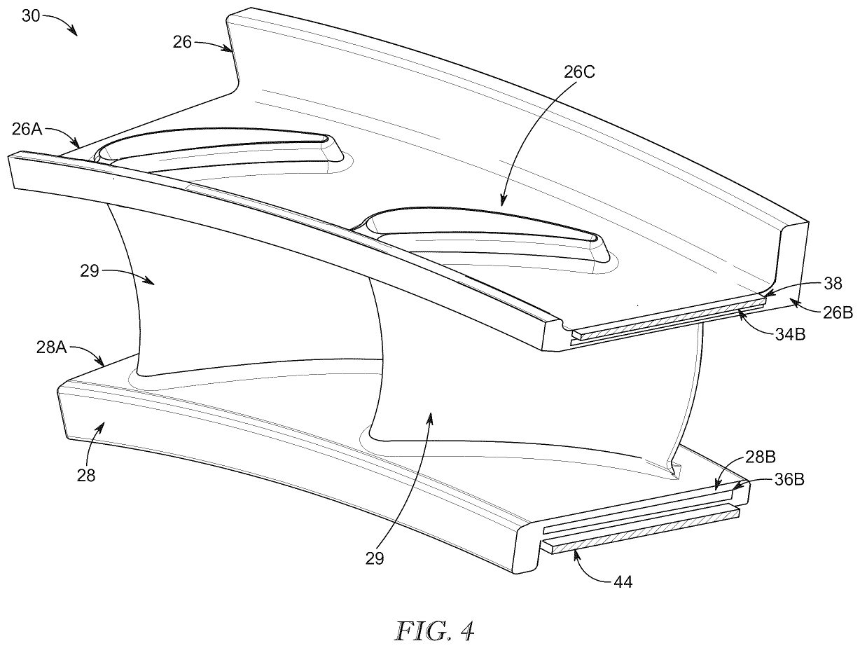

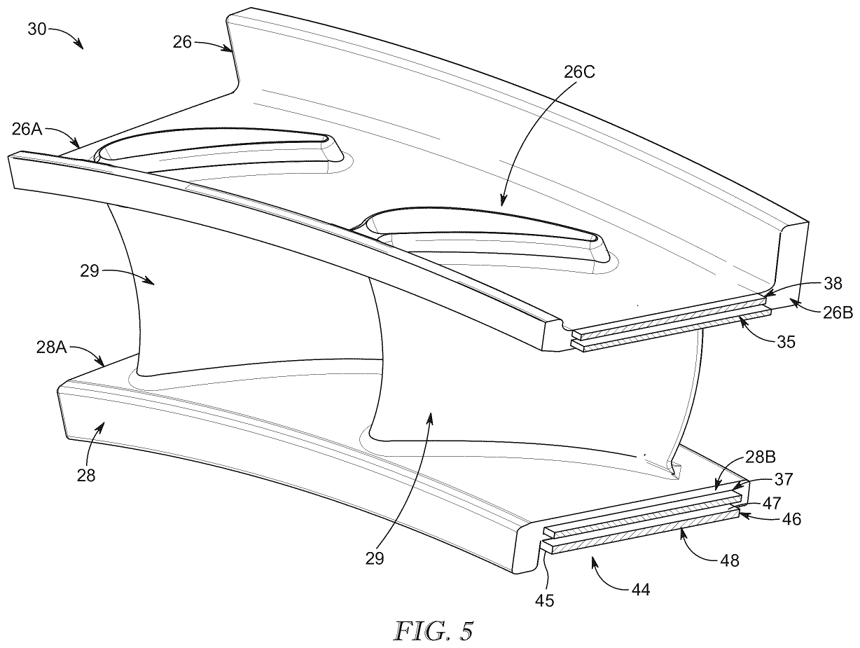

FIG. 3A shows an exemplary annular vane ring 24 which can be arranged within the turbine 16 of the engine 10, the vane ring 24 having been formed via additive layer manufacturing. As can be seen in FIG. 3A, the vane ring 24 includes an outer vane platform 26, an inner vane platform 28, and a plurality of vanes 29 extending therebetween. The outer and inner vane platforms 26, 28, which can be seen in greater detail in FIGS. 4 and 5, are formed in segments so as to define distinct vane assemblies 30 arranged circumferentially adjacent to each other in an annular fashion to create the annular vane ring 24. Illustratively, as shown in FIGS. 4 and 5, each vane assembly 30 includes two vanes 29 extending between a segmented outer vane platform 26 and a segmented inner vane platform 28, although more or fewer vanes 29 may be included on each vane assembly 30 based on the size of the vane ring 24 and/or the size of the engine 10.

Because the vane assemblies 30 are formed as distinct segments, circumferential gaps 31, 32 are defined between the inner vane platforms 28 and the outer vane platforms 26, as shown in FIG. 3A. In order to block gases flowing through the turbine 16 and over the vanes 30 of the vane ring 24 from escaping the flow path via these circumferential gaps 31, 32, a seal 35, 37 can be arranged within one or more of the gaps 31, 32. Although the entire vane ring 24 is formed via additive layer manufacturing as a single component, the vane assemblies 30 are nevertheless distinct from each other so as to allow for thermal expansion and movement of the assemblies 30 relative to each other. The seals 35, 37 described herein are arranged within circumferentially interfacing sides of the vane assemblies 30 and are constructed or fabricated within the vane assemblies 30 during the additive layer manufacturing process, thus forming the entire vane ring 24 in a single fabrication operation while still allowing for the individual vane assemblies 30 to be distinct and movable relative to each other. It is noted that, in some embodiments, the vane assemblies 30 may not include both seals 35, 37, and in other embodiments, may not include any seals such that only the spacers 38, 44 occupy the gaps 31, 32 between the vane assemblies 30.

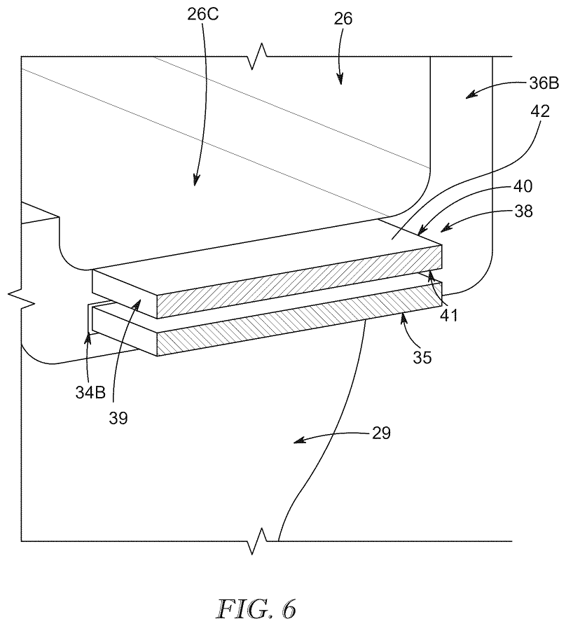

As can be seen in FIGS. 3A and 4-8, an outer seal 35 can be arranged between the outer vane platforms 26 of the vane assemblies 30 and, alternatively or additionally, an inner seal 37 can be arranged between the inner vane platforms 28 of the vane assemblies 30. It is noted that the cross-hatchings of the seals 35, 37 and spacers 38, 44 are shown as different than the cross-hatching of the surrounding components (i.e. the outer and inner vane platforms 26, 28) in FIGS. 3B, 7, 8, and 10, not to indicate that the seals and spacers are formed of a different material that the surrounding components, but simply to illustrate that the seals and spacers are different components in that the seals can be machined in the grooves of the vane assemblies and the spacers can be removed after the vane ring is additively manufactured. In some embodiments, the seals and/or spacers may be formed of a different material than the surrounding components (i.e. the outer and inner vane platforms 26, 28), via methods such as, for example, multi-material additive manufacturing.

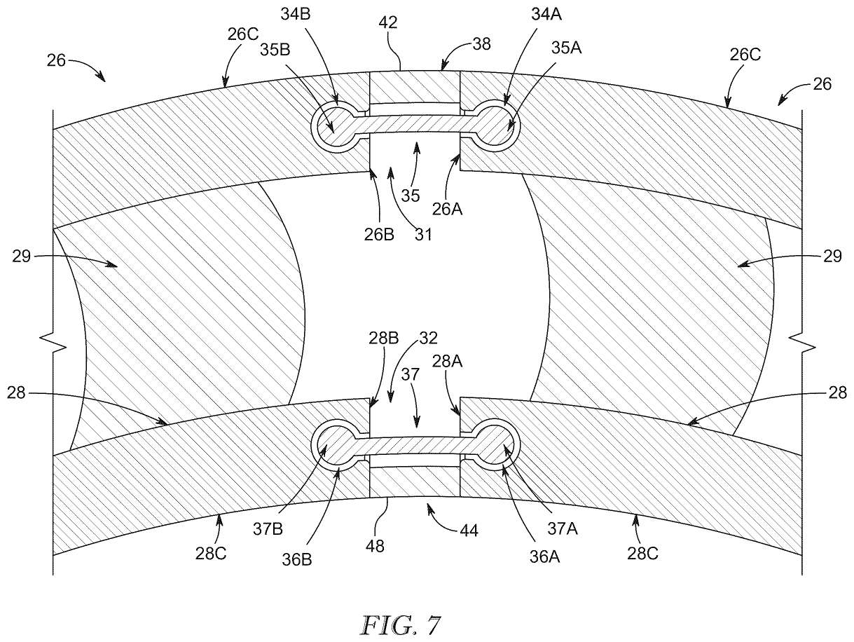

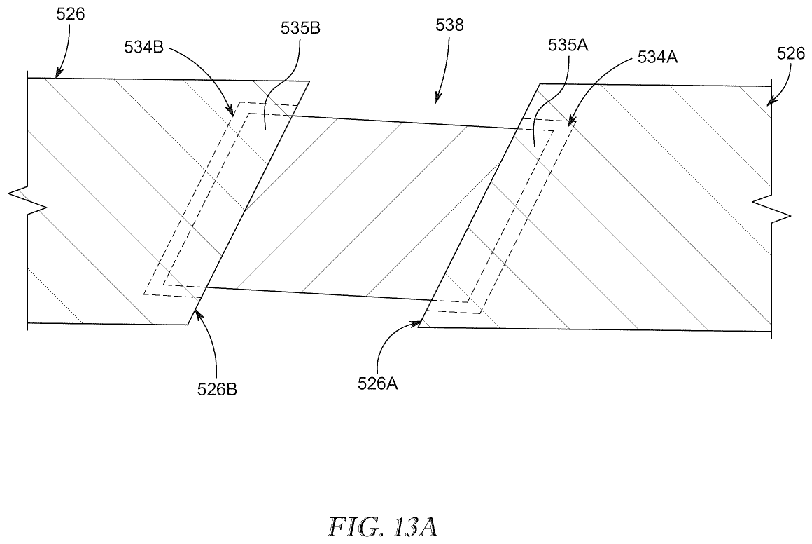

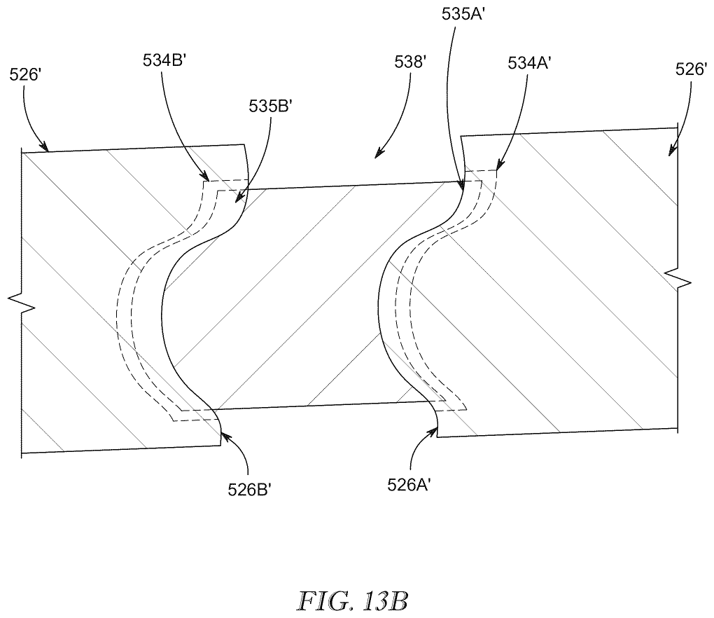

As can be seen in FIGS. 4-7, the outer and inner vane platforms 26, 28 of each vane assembly 30 include circumferentially-facing side walls 26A, 28A, 26B, 28B that face the respective circumferential direction. Specifically, a first vane assembly 30, which can be seen, for example, as the vane assembly 30 on the right of FIG. 7, may include first circumferentially-facing side walls 26A, 28A on the outer and inner vane platforms 26, 28, respectively, that face a first circumferential direction and a second vane assembly 30 arranged adjacent the first vane assembly 30, which can be seen, for example, as the vane assembly 30 on the left of FIG. 7, may include second circumferentially-facing side walls 26B, 28B on the outer and inner vane platforms 26, 28, respectively, that face a second circumferential direction opposite the first circumferential direction. The gaps 31, 32 are defined between the first and second circumferentially-facing side walls 26A, 28A, 26B, 28B. In some embodiments, as will be described in greater detail with regard FIGS. 13A and 13B below, the additive manufacturing lends itself to alternative shapes of the first and second circumferentially-facing side walls 26A′, 28A′, 26B′, 28B′, such as angled, S-shaped, or any other shape.

The outer and inner seals 35, 37 can be formed via the additive layer manufacturing process described herein, in particular formed within a pair of or both pairs of the grooves 34A, 34B, 36A, 36B formed in the outer and inner vane platforms 26, 28, layer-by-layer, during the construction process of the vane assemblies 30. Accordingly, the seals can be formed having shapes that may, in some scenarios, may be challenging to manufacture and/or install via other manufacturing and assembly methods. Even further, more than one seal may be formed between adjacent engine components or vane assemblies 30 in some exemplary embodiments.

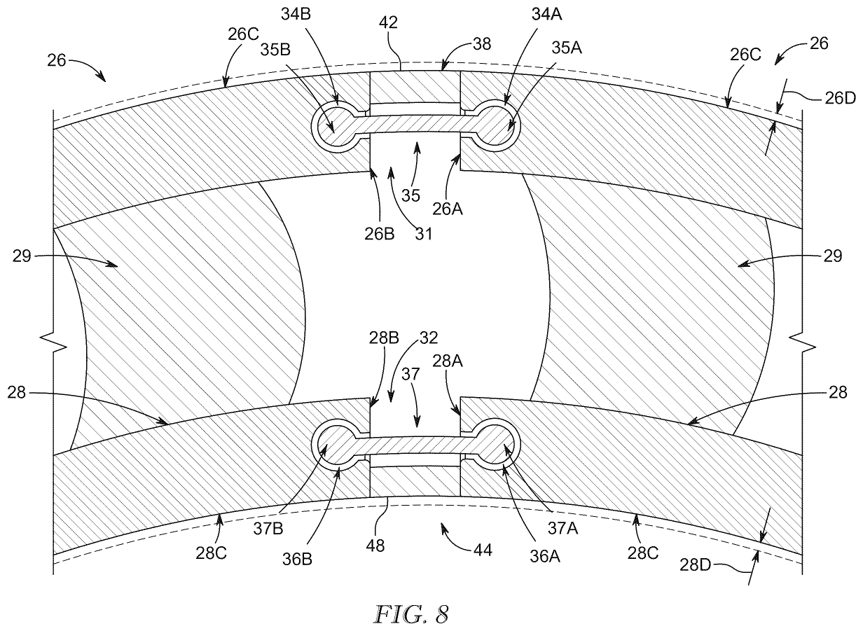

As can be seen in FIGS. 7 and 8, the outer and inner seals 35, 37 can each extend axially within the axially elongated grooves 34A, 34B, 36A, 36B. The seals 35, 37 can be similarly axially elongated bodies that occupy a majority of the axially, radial, and circumferential extents of the grooves 34A, 34B, 36A, 36B (i.e. suspending within the grooves 34A, 34B, 36A, 36B but occupying a majority of the space therein).

Each seal 35, 37 can include a first end having a first projecting portion 35A, 37A and a second end opposite the first end having a second projecting portion 35B, 37B. The projecting portions 35A, 37A, 35B, 37B are formed as axially-extending cylindrical bodies (i.e. as circular when viewed in cross-section as shown in FIGS. 7 and 8) arranged within correspondingly shaped recesses formed in the grooves 34A, 34B, 36A, 36B so as to interlock the seals 35, 37 within the grooves 34A, 34B, 36A, 36B while allowing for thermal expansion and contraction of the vane assemblies 30 relative to each other (i.e. circumferential movement of the adjacent vane assemblies 30 toward and away from each other). The seals 35, 37, due to being suspended within the grooves 34A, 34B, 36A, 36B, can also be pressure-activated by the gases flowing through the gaps 31, 32. The projecting portions 35A, 37A, 35B, 37B, although shown as axially-extending cylindrical bodies can be formed as any shape that is larger than the remaining portion of the seal 35, 37 so as to enable the interlocking functionality of the seals 35, 37 with the grooves 34A, 34B, 36A, 36B.

Illustratively, the annular vane ring 24, in addition to the seals 35, 37, is formed with spacers 38, 44 formed between the first and second circumferentially-facing side walls 26A, 28A, 26B, 28B of the outer and inner vane platforms 26, 28 within the gaps 31, 32. FIG. 2 shows the seals 35, 37 and spacers 38, 44 conceptually about the entirety of an exemplary annular vane ring 24, FIGS. 4 and 5 shows a single vane assembly 30 with the seals 35, 37 and spacers 38, 44 formed therewith, and FIGS. 7 and 8 show two adjacent vane assemblies 30 having seals 35, 37 and spacers 38, 44 formed therebetween. The two adjacent vane assemblies 30 and related seals 35, 37 and spacers 38, 44 may be referred to as an “engine component assembly” herein.

As can be seen in FIGS. 4-6, each spacer 38, 44 can be formed to have a similar overall shape as the seals 35, 37, at least in the area of the gaps 31, 32. In particular, each spacer 38, 44 can be formed as an axially elongated body having a greater axial extent than radial and circumferential extent. Specifically, each spacer 38, 44 includes a first axial face 39, 45 and a second axial face 40, 46 opposite the first axial face 39, 45. Each spacer 38, 44 further includes a first radial face 41, 47 and a second radial face 42, 48 radially spaced apart from the first radial face 41, 47, each of the first and second radial faces 41, 47, 42, 48 extending between and interconnecting opposing radial edges of the first and second axial faces 39, 45, 40, 46.

In some embodiments, as can be seen in FIGS. 4 and 5, the first radial faces 41, 47 are arranged on a side of the spacers 38, 44 closer to the center of the vane assemblies 30 (i.e. closer to the vanes 29) and the second radial faces 42, 48 are arranged on a side of the spacers 38, 44 further from the center of the vane assemblies 30 than the first radial faces 41, 47. In some embodiments, the axial extent of the spacers 38, 44 as measured from the first axial face 39, 45 to the second axial face 40, 46 can be less than the axial extent of the outer and inner vane platforms 26, 28, at least in the area of the spacers 38, 44. The axial length of the spacers 38, 44, as well as the other dimensions of the spacers 38, 44, can be modified based on the structural and support needs of the vane ring 24 design via the utilization of additive layer manufacturing, as will be expanded on below.

As described above, the spacers 38, 44 extend between and interconnect the circumferentially-facing side walls 26A, 26B, 28A, 28B of the outer and inner vane platforms 26, 28 of the vane assemblies 30, as shown in FIGS. 7 and 8. In some embodiments, as can be seen in FIGS. 4-8, the second radial faces 42, 48 are formed to be flush with an outer surface 26C, 28C of the outer and inner vane platforms 26, 28. This may ease the post-processing of the vane assemblies 30, in particular, for example, machining of the outer surfaces 26C, 28C of the vane platforms 26, 28, as will be described in detail below. Specifically, the spacers 38, 44 not extending radially outwardly beyond the outer surfaces 26C, 28C would eliminate the need to first machine off the second radial faces 42, 48 before being able to machine the outer surfaces 26C, 28C. Illustratively, the spacers 38, 44 are formed to be radially spaced apart from the seals 35, 37 such that the spacers 38, 44 can be more easily removed from the vane ring 24 in post-processing without affecting the seals 35, 37 in the removal process.

The spacers 38, 44 are formed so as to be removable from the annular vane ring 24. Specifically, the spacers 38, 44 are removable from the annular vane ring 24 after the additive layer manufacturing process is completed (i.e. after the entire vane ring 24 has been completed). In some embodiments, the spacers 38, 44 could also be removed prior to completion of the entire vane ring 24, but removed at any point mid-fabrication of the vane ring 24.

In order for the spacers 38, 44 to be removable, the spacers 38, 44 may be located so as be mechanically removable from the vane assemblies 30. In some embodiments, this location may refer to any location in which the spacers 38, 44 may be physically accessed so as to be removed from the annular vane ring 24. Exemplary locations may include, but are not limited to, the locations shown in FIGS. 4-8 which allow for the spacers 38, 44 to be accessed via outside machining means for removal. In other exemplary embodiments, the spacers 38, 44 may be located on the inside of the seals 35, 37 (i.e. toward the vanes 29). In this location, the spacers 38, 44 may be accessed axially via outside machining means (radial access would likely be at least partially blocked by the seals 35, 37). The removal of the spacers 38, 44 may be completed, for example, via machining the spacers 38, 44 off of the vane ring 24 in post-processing. This can occur during or after all surfaces that require machining have been modified.

In some embodiments, in addition to or alternatively to being able to be mechanically removed from the vane assemblies 30, the spacers 38, 44 may be formed of a material that can be chemically etched in post-processing, also known as chemical etching. Such materials may include high temperature metals that may include, as a non-limiting example, Nickel alloys. A chemical agent can be applied to the spacers 38, 44 during or after the additive layer manufacturing process such that the spacers 38, 44 etch away from the vane assemblies 30 and thus are removed therefrom. Chemical agents that may be utilized for this process may include, but are not limited to, hydrocholoric acid, nitric acid and ferric chloride.

Prior to being removed, the spacers 38, 44 can provide structural support for adjacent vane assemblies 30 (i.e. the “engine component assembly”) at least during the additive manufacturing of the vane assemblies 30 and the overall vane ring 24. Moreover, the spacers 38, 44 may also provide structural support at least during post-processing machining of the vane assemblies 30 of the vane ring 24 after the additive manufacturing process is completed. Specifically, in some embodiments, during or after the vane ring 24 is completed, key surfaces and interfaces of the vane assemblies 30, such as, for example, the outer surfaces 26C, 28C of the outer and inner vane platforms 26, 28 (shown in FIG. 8 in phantom lines) may be machined by a distance of 26D (i.e. material removed therefrom so as to form the final desired shape of the vane assemblies 30). The spacers 38, 44 may provide support to the vane assemblies 30 and the entire overall vane ring 24 during this machining process.

Additionally, the spacers 38, 44 maintain adjacent vane assemblies 30 in the same position relative to each other and other vane assemblies 30 throughout the entire post-processing machining process. Thus, all surfaces that require machining during post-processing, such as, for example, the outer surfaces 26C, 28C of the outer and inner vane platforms 26, 28, may be machined relative to the same datum structure (i.e. the same centerline) which is maintained by the spacers 38, 44. This removes some tolerance stack up between vane assemblies 30 (i.e. physical gap size), and therefore, less leakage can be obtained. Therefore, less leakage can be obtained due to smaller nominal gaps.

Additionally, additive layer manufacturing may cause heat build up that can also affect thermal stress and tolerance issues. For example, during the additive manufacturing process, heat is added due to the energy source 302, which causes thermal stresses accumulate in the vane assemblies. Depending on the specific geometry, these stresses can cause the components of the vane assemblies to become warped and out of tolerance. The spacers 38, 44 can aid in fighting the thermal loads and maintain an actual geometry that is closer to the nominal dimensions (smaller tolerance).

Although the vane ring 24 is shown as including outer and inner spacers 38, 44 within each gap 31, 32 between all of the outer and inner vane platforms 26, 28 of adjacent vane assemblies 30, any number of and combination of outer and inner spacers 38, 44 may be arranged around the circumferential extent of the annular vane ring 24 within the gaps 31, 32. In some non-limiting examples, the vane ring 24 may only include outer spacers 38 between each vane assembly 30, may only include inner spacers 44 between each vane assembly 30, may include outer spacers 38 between some vane assemblies 30 and inner spacers 44 between the remaining vane assemblies 30, or any combination thereof. In other non-limiting examples, more or fewer spacers 38, 44 than those shown in FIG. 2 may be utilized in the vane ring 24 to provide additional support, such as one outer spacer 38 and two inner spacers 44 arranged between each outer and inner vane platform 26, 28.

As described above, the vane assemblies 30 are formed via additive layer manufacturing which, among other advantages, provides for a highly accurate fabrication and machining process. Moreover, the additive layer manufacturing methods described herein provide great flexibility in the formation of the vane assemblies 30, in particular, relevant-most to this disclosure, great flexibility in the formation of the spacers as well the seals. For example, forming the vane assemblies 30 and thus the overall annular vane ring 24 via additive layer manufacturing allows for the spacers to be formed in a wide variety of configurations and locations, thus providing support in specific areas necessary for the overall fabrication of the vane ring 24. In the context of the embodiments described above, in one non-limiting example, the spacers can be formed radially inward of the seals between some pairs of vane assemblies if support is required in this region. In other non-limiting examples, multiple spacers can be formed between some pairs of vane assemblies if additional support is required in these areas. These variations in the formation of the spacers can more easily be realized in the vane ring 24 via the utilization of additive layer manufacturing.

Another advantage of the additive layer manufacturing process of the vane ring 24 is that the seals 35, 37, 135, 137, 235, 237 described herein are essentially locked into place via the projecting portions. As a result, the likelihood of the seals escaping the grooves during operation of the engine 10 is significantly reduced, as there are no openings, other than the gaps 31, 32, through which the seals may escape during operation of the engine 10. The enclosed nature of the grooves also eases assembly of the vane assemblies since, as noted above, the seals do not have to be manually inserted into the grooves during assembly.

The additive manufacturing methods described herein, in particular forming the described vane assemblies and engine components including the spacers and seals therebetween, can further result in less tolerance stack, which can result in a more streamlined design process. Furthermore, forming the vane assemblies and/or engine components in a single fabrication operation can reduce overall machining time, as well as potentially reducing the number of tools required for manufacturing, inspection, and assembly.

Even further, the sizes of the spacers described herein can be varied utilizing additive layer manufacturing, potentially streamlining the additive manufacturing process and reducing cost. For example, using the smaller cylindrical spacers 138A, 138B, 138C as opposed to larger spacers 38, 44 can reduce material used, thus reducing cost, but these spacers can also potentially be less rigid and thus reduce strength. Various combinations of spacers described herein may be used based on the design and machining to be performed on the vane assembly 24.

A method according to a further aspect of the present disclosure includes additively manufacturing an engine component assembly (i.e. vane assemblies 30) of a gas turbine engine 10 including a first vane assembly 30, a second vane assembly 30, and a first spacer 38, 44 between the first and second vane assemblies 30 such that the first and second vane assemblies 30 and the first spacer 38, 44 are formed in a single fabrication operation. The additive manufacturing of the first and second vane assemblies 30 and the first spacer includes 38, 44 forming a first vane platform 26, 28 of the first vane assembly 30 that extends circumferentially about a central axis 11 of the gas turbine engine 10 and a first vane 29 extending radially away from the first vane platform 26, 28 and configured to interact with gases 17 flowing through the gas turbine engine 10, the first vane platform 26, 28 having a first side wall 26A, 28A.

The method can further include forming a second vane platform 26, 28 of the second vane assembly 30 adjacent to the first vane platform 26, 28 that extends circumferentially about the central axis 11 and a second vane 29 extending radially away from the second vane platform 26, 28 and configured to interact with the gases 17, the second vane platform 26, 28 having a second side wall 26B, 28B facing the first side wall 26A, 26B.

The method can further include forming the first spacer 38, 44 between the first and second vane platforms 26, 28 of the first and second vane assemblies 30, the first spacer 38, 44 extending between and interconnecting the first and second side walls 26A, 26B, 28A, 28B. The first spacer 38, 44 provides structural support for the engine component assembly (i.e. vane assemblies 30) at least during the additive manufacturing of the engine component assembly (i.e. vane assemblies 30) and during post-processing machining of the engine component assembly (i.e. vane assemblies 30) after the additive manufacturing.

The additive layer manufacturing process can include, for example, steps of forming the vane assemblies or engine components described herein, layer-by-layer, via a repetitive process of adding layers of a base material, manipulating the base material via an energy source, and solidifying the layer before moving to the next layer. The additive layer manufacturing process may include similar processes, including additional or alternative steps to these basic steps, known to those skilled in the art, so long as the assemblies are formed in a single fabrication process or operation in a layer-by-layer fashion. Although an axial build direction is shown as an illustrative build direction in FIG. 3B, the vane ring 24 may be fabricated in any of the axial, radial, and circumferential directions, and any combination thereof.

FIG. 3B shows a non-limiting example of an additive manufacturing process in an axial direction of the outer platforms 26 of a pair of adjacent vane assemblies 30 and spacer 38 of the vane ring 24. The process may include adding a first layer 306 of additive powder material to a build platform 301 of an additive layer manufacturing machine 300. The first layer 306 can be one of the axial sides (i.e. an axially forwardmost or an axially aftmost side) of the adjacent vane assemblies 30. The process can further include projecting an energy source 302 at the first layer 306 so as to selectively form a desired geometry on the first layer 306, and solidifying the first layer 306 having the desired geometry. In some embodiments, a recoder arm (not shown) can smooth the powder material and remove partially solidified material from splatter from source energy between the steps of projecting the energy source 302 and solidifying the layer 306.

The method can further include repeatedly stacking successive layers 308 on top of one another, in particular via lowering the build platform 301, adding additional additive powder material to a previous layer 308, projecting the energy source 302 on the successive layer 308, and solidifying the successive layer 308 to additively manufacture the vane assemblies described herein (also referred to as “engine components”), such as the vane assemblies 30, seals 35, 37, and spacers 38, 44 described above. It is noted that the layers 306, 308 shown in FIG. 3B are shown much larger than actual size in order to illustrate the concepts described herein. Although this exemplary fabrication process shows specific sizes and orientations of layers, other configurations of layers, as well as formation in other directions of the vane ring 24 such as axially, circumferentially, or any combination of directions, are contemplated by the present disclosure.

A method according to a further aspect of the present disclosure includes forming a first engine component (i.e. vane assembly 30, although other engine components are contemplated herein, as described above) of a gas turbine engine 10 including a first side wall (i.e. side walls 26A, 28A), forming a second engine component of the gas turbine engine 10 arranged adjacent to the first engine component and including a second side wall (i.e. side walls 26B, 28B) facing the first side wall, forming a first spacer 38, 44 between the first and second engine components, the first spacer 38, 44 extending between and interconnecting the first and second side walls of the first and second engine components, machining at least one surface of the first and second engine components so as to remove material from the at least one surface, and, after machining the at least one surface, removing the first spacer 38, 44 from between the first and second engine components. The at least one surface may include a surface on one of the first and second engine components, or surfaces on both engine components, such as, for example, the removal of material shown in FIG. 8 and described herein. It is noted that, although only the spacers 38, 44 are referred to with regard to this method, any and all combinations of spacers described herein, as well as the various vane assemblies described herein, are contemplated by the present disclosure.

In some embodiments, in particular embodiments in which the components of the vane ring 24 are comprised of material that can be chemically etched or milled, the method can further include adding additional spacers, such as the cylindrical spacers 439A, 439B, 439C that have the small end portions 439A1, 439A2 configured to chemically etch away, between the vane assemblies 30, which may be located, for example, in areas that are difficult to reach for mechanical removal of the spacers 38, 44, 439A, 439B, 439C. This can be done prior to the machining of the at least one surface of the engine components. Also prior to the machining, the entire vane assembly 24 can then be arranged in a bath of a chemical agent, as described herein, to remove at least some material from the outer surfaces of the components of the vane assembly 24. In this process, the small end portions 439A1, 439A2 dissolve away allowing for the cylindrical spacers 439A, 439B, 439C to be eventually removed. After the bath in the chemical agent that dissolves the end portions 439A1, 439A2, the at least one surface of the first and second engine components can be machined, and then subsequently, the larger spacers 38, 44 can be removed mechanically. As noted herein, in some embodiments, the spacers 38, 44 can also be removed chemically.

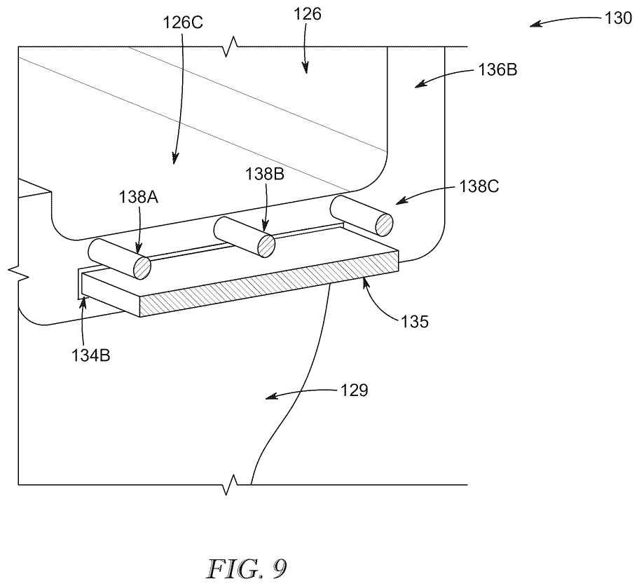

Another embodiment of spacers 138A, 138B, 138C of vane assemblies 130 that are configured to be utilized in the vane ring 24 of the gas turbine engine 10, as well as the methods described herein, is shown in FIG. 9. The spacers 138A, 138B, 138C and vane assemblies 130 are similar to the spacers 38, 44 of vane assemblies 30 described herein. Accordingly, similar reference numbers in the 100 series indicate features that are common between the spacers 138A, 138B, 138C of the vane assemblies 130 and the spacers 38, 44 of the vane assemblies 30. The description of the spacers 38, 44 of vane assemblies 30 is incorporated by reference to apply to the spacers 138A, 138B, 138C and vane assemblies 130, except in instances when it conflicts with the specific description and the drawings of the spacers 138A, 138B, 138C and vane assemblies 130.

The spacers 138A, 138B, 138C and vane assemblies 130 are formed similarly to the spacers 38, 44 described herein. Unlike the spacers 38, 44, the spacers 138A, 138B, 138C of the present embodiment are not formed as axially elongated bodies, but instead are formed as circumferentially-extending cylindrical bodies that are separated axially from each other. In some embodiments, the spacers 138A, 138B, 138C occupy generally the same area on the side walls 26A, 26B, 28A, 28B as the spacers 38, 44. Illustratively, the three spacers 138A, 138B, 138C are spaced apart equal distances, although in some embodiments, two of the three spacers 138A, 138B, 138C may be closer to each other than the other two spacers 138A, 138B, 138C based on where support is most needed between the vane assemblies 130. Although three spacers 138A, 138B, 138C are shown, the present disclosure contemplates the usage of more or fewer spacers 138A, 138B, 138C based on the design needs of the vane assemblies 130 and overall vane ring 24.

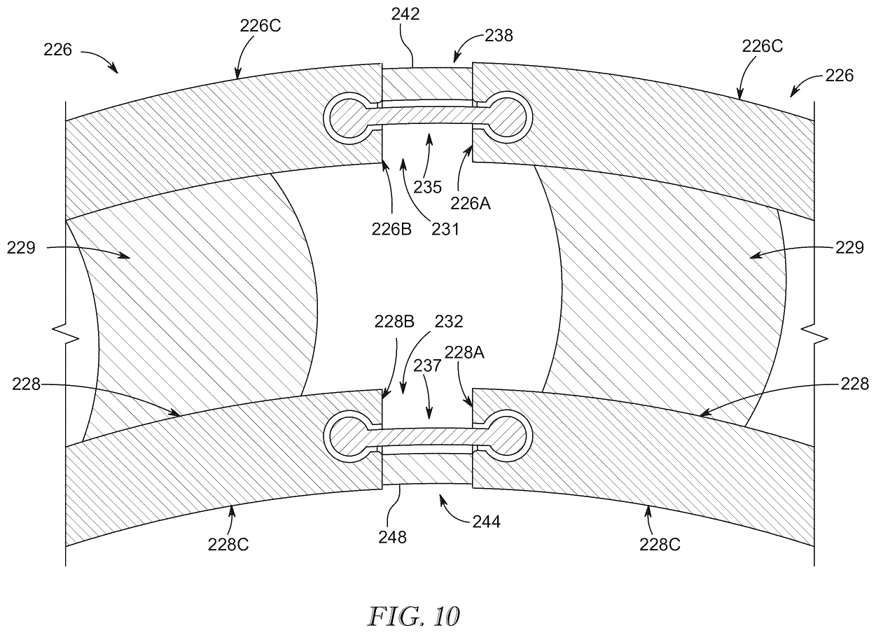

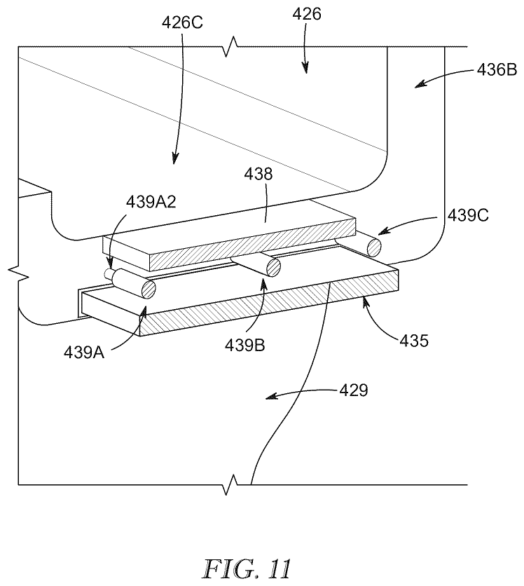

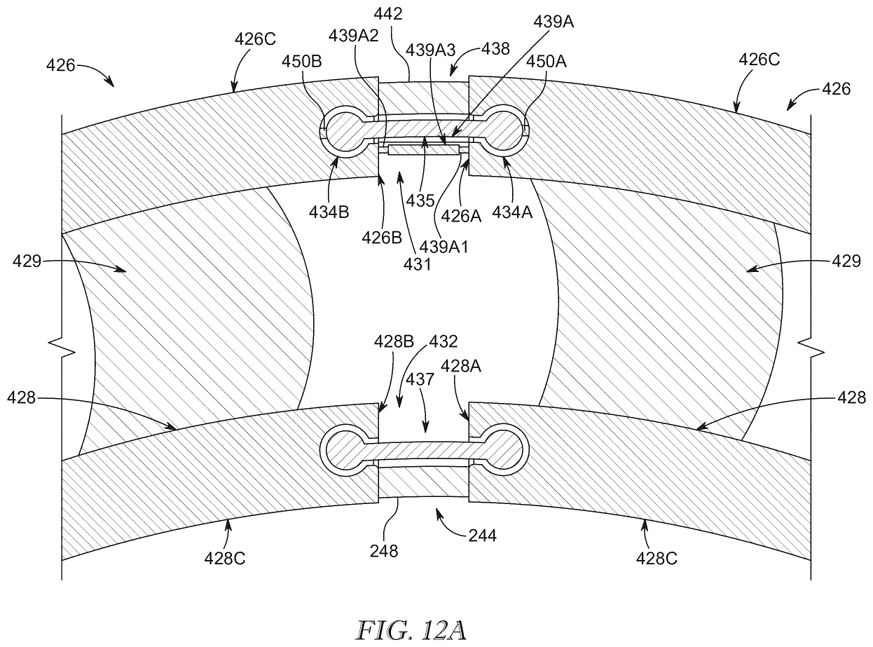

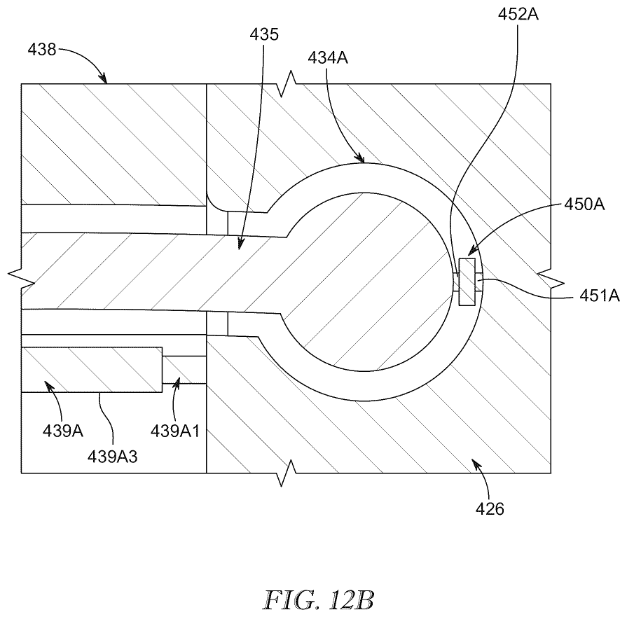

It is noted that FIG. 9 is indicative of how the spacers can be arranged in different axial positions relative to those shown in FIGS. 2-8, in particular as cylindrical bodies arranged at different axial positions as compared to the spacers 38, 44. FIG. 10, the details of which are described below, is indicative of how the spacers can be arranged in different radial positions. Moreover, one or more of the spacers 138A, 138B, 138C can be arranged between the inner platforms (see FIG. 8A, inner platforms 28) in addition to or alternatively to the outer platforms 126. Any combination of the spacers 138A, 138B, 138C between the inner and outer platforms of the vane assemblies 130 is contemplated by the present disclosure, such as radially inwardly (towards the center of the vane assembly) of the seals, some radially inward of and some radially outward of the seal (relative to the center of the vane assembly), axially offset relative to the seal, and any other position. The spacers 138A, 138B, 138C can be arranged radially outside of the seal (relative to the center of the vane assembly) such that they can be accessed to be mechanically removed during post-processing. FIGS. 11-12B show an embodiment in which the spacers can be removed via chemical etching or milling.

Another embodiment of spacers 238, 244 of vane assemblies 230 that are configured to be utilized in the vane ring 24 of the gas turbine engine 10, as well as the methods described herein, is shown in FIG. 10. The spacers 238, 244 and vane assemblies 230 are similar to the spacers 38, 44, 138A, 138B, 138C of vane assemblies 30, 130 described herein. Accordingly, similar reference numbers in the 200 series indicate features that are common between the spacers 238, 244 of the vane assemblies 230 and the spacers 38, 44, 138A, 138B, 138C of the vane assemblies 30, 130. The descriptions of the spacers 38, 44, 138A, 138B, 138C of the vane assemblies 30, 130 are incorporated by reference to apply to the spacers 238, 244 and vane assemblies 230, except in instances when it conflicts with the specific description and the drawings of the spacers 238, 244 and vane assemblies 230.

The spacers 238, 244 and vane assemblies 230 are formed essentially the same as the spacers 38, 44 and vane assemblies 30 described herein. The spacers 238, 244 differ from the spacers 38, 44 in that the spacers 238, 244 are arranged in a different radial position than the spacers 38, 44. Specifically, the spacers 238, 244 can be arranged radially closer to the seals 235, 237 than the spacers 38, 44 are arranged relative to the seals 35, 37 (i.e. towards a center of the vane assemblies 30, which is towards the vanes 29). As can be seen in FIG. 10, the second radial surfaces 242, 248 of the spacers 238, 244 are not flush with the outer surfaces 226C, 228C of the vane platforms 226, 228, and thus would not interfere with machining of the outer surfaces 226C, 228C during post-processing. As noted herein, alternative radial positions of the spacers 238, 244 are possible, such as even closer to the seals 235, 237 or on the opposing side of the seals 235, 237. Being able to selectively modify the radial position of the spacers 238, 244 can be useful in positioning spacers for ease of access or where areas need additional support, and to ease conventional or non-conventional machining such as chemical etching or milling, or electrical discharge machining (EDM) to remove the chemically etchable supports.

Another embodiment of spacers 438, 439A, 439B, 439C of vane assemblies 230 that are configured to be utilized in the vane ring 24 of the gas turbine engine 10, as well as the methods described herein, is shown in FIGS. 11-12B. The vane assemblies 430 and its components including the spacers 438, 439A, 439B, 439C are similar to the vane assemblies 30, 130, 230 and its components including their spacers described herein. Accordingly, similar reference numbers in the 400 series indicate features that are common between the spacers 438, 439A, 439B, 439C of the vane assemblies 430 and the spacers of the vane assemblies 30, 130. The descriptions of the spacers of the vane assemblies 30, 130 are incorporated by reference to apply to the 438, 439A, 439B, 439C and vane assemblies 430, except in instances when it conflicts with the specific description and the drawings of the 438, 439A, 439B, 439C and vane assemblies 430.

The spacers 438, 439A, 439B, 439C and vane assemblies 430 are formed essentially the same as the spacers 38, 44, 138A, 138B, 138C and vane assemblies 30 described herein. FIGS. 11-12B show that a combination of both spacers 438 formed similar to the spacers 38, 44 and cylindrical body-style spacers 439A, 439B, 439C similar to the spacers 138A, 138B, 138C. As can be seen in FIG. 11, a non-limiting example of the position of the spacers 438, 439A, 439B, 439C can include arranging the cylindrical body spacers 438, 439A, 439B, 439C radially between the spacer 438 and the seal 435. The arrangement of the spacers 438, 439A, 439B, 439C can vary depending on optional positioning of the spacers 439A, 439B, 439C, in particular when the spacers 439A, 439B, 439C are configured to be chemically etched or milled, as described below.

In some embodiments, as can be seen in FIGS. 11-12B, the spacers 439A, 439B, 439C can include end portions 439A1, 439A2 (not shown with relation to spacers 439B, 439C, but the same end portions can be part of these spacers as well) that are formed to have a smaller diameter than a main body portion 439A3 of the spacer 439A. In such embodiments, the spacers 439A, 439B, 439C may be formed of a material that allows for the spacers 439A, 439B, 439C to be chemically etched or milled so that they can be removed from the vane assemblies 430 in post-processing, similar to the process described above.

The chemical etching or milling allows for the spacers 439A, 439B, 439C, which are smaller than the large, axially-elongated spacer 438, to be placed in areas of the vane assemblies 430 that may be difficult to reach for mechanical removal of the spacers 439A, 439B, 439C. A non-limiting example of such a position of the spacers 439A, 439B, 439C includes being arranged radially inward from the seal 435, as shown in FIG. 12A. In other non-limiting examples, additional cylindrical spacers 450A, 450B that also include end portions with small diameters (see FIG. 12B, end portions 451A, 452A) may be arranged in the grooves 434A, 434B between the projecting portions 435A, 435B of the seal 435 and the inner surface of the grooves 434A, 434B, which is an area that is likely inaccessible for mechanical removal of the spacer 450A, 450B. It is noted that the seal and spacer arrangements shown in FIGS. 11-12B also apply to the inner platform in addition to the outer platform 426.

In some embodiments, the completed vane ring 24 may be placed in a bath of the chemical agent described above. Because the chemical agent can contact all portions of the vane ring 24, the same amount of material may be removed from an outer surface layer all portions of the vane ring 24. In such embodiments, the diameter of the end portions 439A1, 439A2 may be less than or equal to twice the material that is being removed from the entire vane ring 24 such that the end portions 439A1, 439A2 dissolve, thus allowing for the spacers 439A, 439B, 439C, 450A, 450B to be removed without removing too much material from the overall vane ring 24. Another embodiment of spacers 538 of vane assemblies 530 that are configured to be utilized in the vane ring 24 of the gas turbine engine 10, as well as the methods described herein, is shown in FIGS. 13A and 13B. The vane assemblies 530 and its components including the spacers 538 are similar to the vane assemblies 30, 130, 230, 430 and its components including their spacers described herein. Accordingly, similar reference numbers in the 500 series indicate features that are common between the spacers 538 of the vane assemblies 530 and the spacers of the vane assemblies 30, 130, 230, 430. The descriptions of the spacers of the vane assemblies 30, 130, 230, 430 are incorporated by reference to apply to the spacers 538 and vane assemblies 530, except in instances when it conflicts with the specific description and the drawings of the spacers 538 and vane assemblies 530.

In some embodiments, as shown in FIGS. 13A and 13B, the first and second circumferentially-facing side walls 526A, 528A, 526B, 528B, 526A′, 528A′, 526B′, 528B′ do not need to be need to be facing each other directly circumferentially (i.e. the side walls being parallel to the axial direction), but may be angled relative to the axial direction. FIG. 13A shows the side walls 526A, 528A, 526B, 528B angled relative to the axial direction, as well as parallel with each other. In some embodiments, the side walls 526A, 528A, 526B, 528B may be formed at different angles and/or not parallel with each other. Other shapes of the first and second circumferentially-facing side walls are contemplated by the present disclosure, such as, for example, an S-shape when viewed axially (shown as side walls 526A′, 528A′, 526B′, 528B′ in FIG. 13B), a curved shape when viewed axially, and the like. The grooves 534A, 534B, 534A′, 534B′ and seals 535 may be formed to match the angle/shape of the side walls 526A, 528A, 526B, 528B, 526A′, 528A′, 526B′, 528B′.

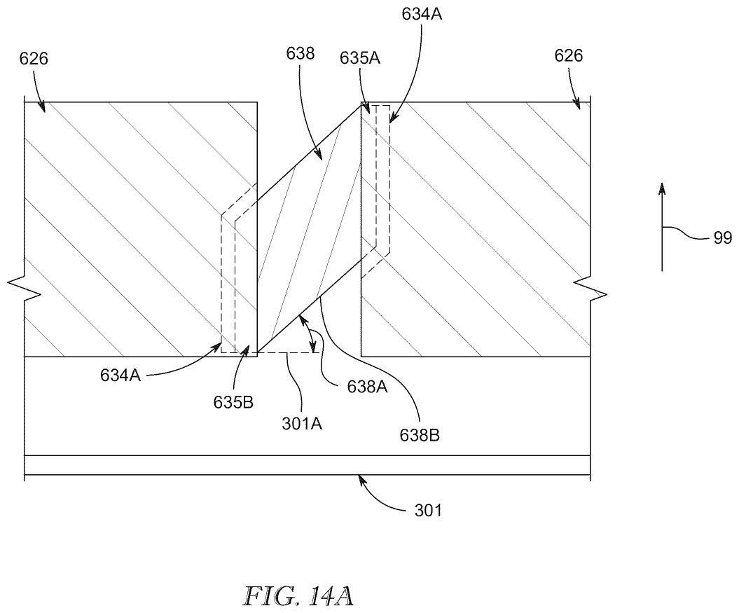

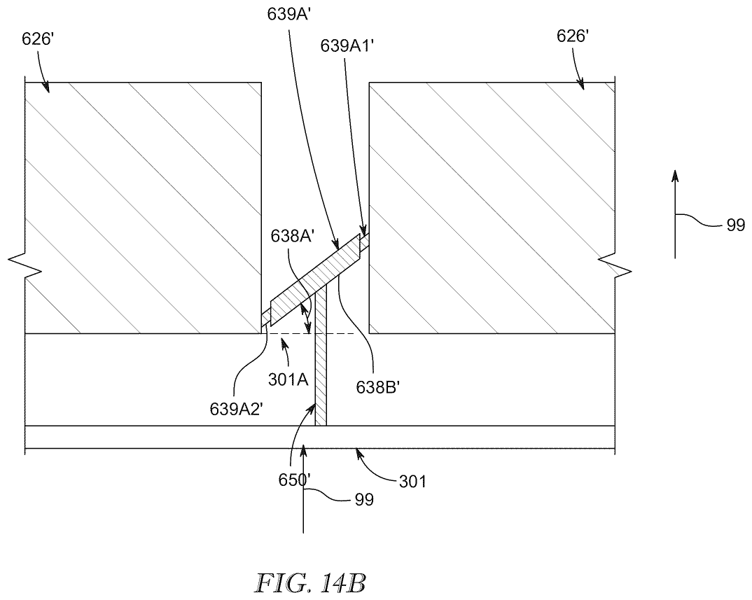

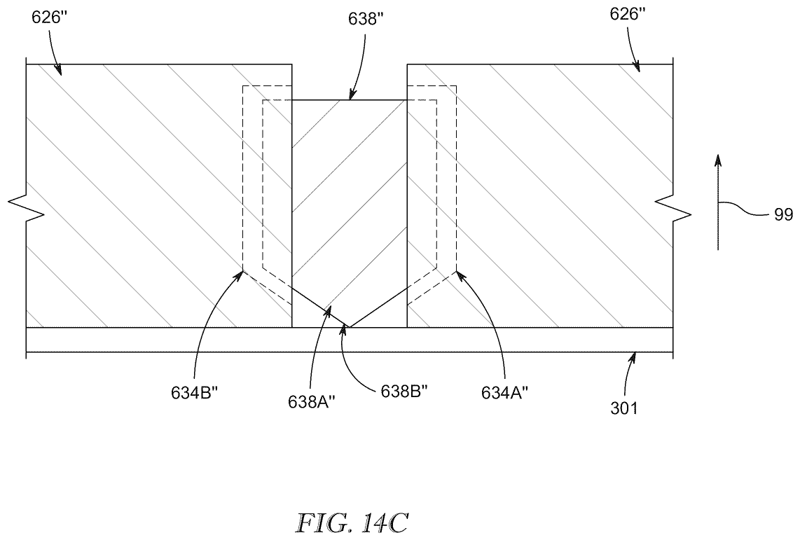

Another embodiment of spacers 638 of vane assemblies 630 that are configured to be utilized in the vane ring 24 of the gas turbine engine 10, as well as the methods described herein, is shown in FIGS. 14A-14C. The vane assemblies 630 and its components including the spacers 638 are similar to the vane assemblies 30, 130, 230, 430, 530 and its components including their spacers described herein. Accordingly, similar reference numbers in the 600 series indicate features that are common between the spacers 638 of the vane assemblies 630 and the spacers of the vane assemblies 30, 130, 230, 430, 530. The descriptions of the spacers of the vane assemblies 30, 130, 230, 430, 530 are incorporated by reference to apply to the spacers 638 and vane assemblies 630, except in instances when it conflicts with the specific description and the drawings of the spacers 638 and vane assemblies 630.

The spacers 638, 638′, 638″ described with reference to FIGS. 14A-14C may be formed similarly any of the spacers described herein, including, by way of non-limiting example, the spacers 38, 44 (FIGS. 14A and 14C) and the cylindrical spacers 439A, 439B, 439C (FIG. 14B). The spacers 638, 638′, 638″ differ in that instead of being formed such that the lower axial surface 638B, 638B′, 638B″ is formed to be parallel to the build platform 301, the spacers 638, 638′, 638″ may be built up in the additive layer manufacturing process in an angled manner, as shown in FIGS. 14A-14C. In addition to being angled relative to the build platform 301, the spacers 638, 638′, 638″ are also angled relative to the circumferentially-facing surfaces of the vane assemblies 630.

For example, as shown in FIG. 3B, one exemplary build direction of the vane ring 24 may be axially (also indicated as direction 99 in FIG. 14A). FIG. 3B shows the lower axial surface 38B of the spacer 38 as being parallel with the build platform 301. As shown in FIG. 14A, the lower axial surface 638B may be built up at an angle 638A relative to the build platform 301 (parallel line 301A shown to illustrate angle 638A). Forming the spacers 638 at the angle 638A may aid in increasing the strength of the spacers 638 as compared to the spacers 638 extending parallel to the build platform 301. In other words, the angled spacer 638 provides self-supported geometry, which reduces the amount of material required to build the vane assemblies 630, at least in part due to not having to form supports for areas of the spacer 638 that may be unsupported due to gravity or other forces, and also reduces the time required to build the vane assemblies 630.

In some embodiments, cylindrical spacers (shown as cylindrical spacer 639A′ having small, chemically-etchable end portions 639A1′, 639A2′ in FIG. 14B) may be formed at an angle 638A′ relative to the build platform 301. Although the angled nature of the cylindrical spacer 639A′ may increase strength, there still may be a relative lack of support in the central area of the spacer 639A′. In particular, gravity may pull on the spacer 639A′ in a direction opposite of the build direction 99. In order to provide support to the spacer 639A′ and combat gravity acting on the spacer 639A′ during the build process, at least one sacrificial support 650′ may be formed between the build platform 301 and the lower axial surface 638. The sacrificial support 650′ may be chemically etched or milled away in order to remove the support 650′ prior to post-processing of the vane ring 24.

The angle 638A, 638A′ may be in a range between and including 10 degrees to 80 degrees, and in some embodiments, between and including 20 to 70 degrees, and in some embodiments, between and including 30 and 60 degrees, and in some embodiments, may be approximately 45 degrees.

In some embodiments, as shown in FIG. 14C, the spacer 639″ may include a protruding support 638A″ that defines the lower axial surface 638B″. The protruding support 638A″ may be formed as a triangle when viewed in the radial direction shown in FIG. 14C such that the point of the triangle faces opposite the build direction 99. The point may be formed on the build platform 301 so as to support the remainder of the spacer 638″ being built up. Although a triangle is shown, any other shape capable of supporting the spacer 638″ as it is being built up may be utilized. In some embodiments, the protruding support 638A″ may be removed, via machining, chemical etching, or other means, during post-processing.

It is noted that similar angling and supporting of the spacers described herein may be applied to any of the spacers described herein. For example, the spacers described herein may be formed at an angle relative to the build platform, regardless of the build direction (axially, radially, circumferentially, or any combination thereof). Moreover, any of the spacers described herein may include one or more sacrificial supports or the protruding supports extending between them and the build platform in a direction along the build direction (and in particular regarding the protruding supports, extending in a direction opposite the build direction) so as to provide support to the spacer and combat gravity acting of the spacer during building up of the spacer in the additive manufacturing process.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A method comprising
additively manufacturing an engine component assembly of a gas turbine engine including a first vane assembly, a second vane assembly, and a first spacer between the first and second vane assemblies such that the first and second vane assemblies and the first spacer are formed in a single fabrication operation, the additive manufacturing of the first and second vane assemblies and the first spacer includes
forming a first vane platform of the first vane assembly that extends circumferentially about a central axis of the gas turbine engine and a first vane extending radially away from the first vane platform and configured to interact with gases flowing through the gas turbine engine, the first vane platform having a first side wall,
forming a second vane platform of the second vane assembly adjacent to the first vane platform that extends circumferentially about the central axis and a second vane extending radially away from the second vane platform and configured to interact with the gases, the second vane platform having a second side wall facing the first side wall, and
forming the first spacer between the first and second vane platforms of the first and second vane assemblies, the first spacer extending between and interconnecting the first and second side walls, wherein the first spacer provides structural support for the engine component assembly at least during the additive manufacturing of the engine component assembly and during post-processing machining of the engine component assembly after the additive manufacturing.

2. The method of claim 1, wherein the first spacer is removable such that the first spacer is configured to be removed from the engine component assembly after the additive manufacturing of the engine component assembly, and wherein the first spacer is at least one of located so as be mechanically removable or formed of a material so as to chemically removable.

3. The method of claim 2, further comprising
machining at least one surface of the engine component assembly so as to remove material from the at least one surface, and
after machining the at least one surface, removing the first spacer from the engine component assembly.

4. The method of claim 3, wherein the first side wall is a first circumferentially-facing side wall of the first vane platform that faces in a first circumferential direction and the second side wall is a second circumferentially-facing side wall of the second vane platform that faces in a second circumferential direction opposite the first circumferential direction.

5. The method of claim 4, wherein the additive manufacturing of the first and second vane assemblies and the first spacer further includes
forming a third vane platform of the first vane assembly that extends circumferentially about a central axis of the gas turbine engine radially spaced apart from the first vane platform, the first vane extending between and interconnecting the first and third vane platforms, the first and third vane platforms being radially outer and inner vane platforms of the first vane assembly, respectively, the third vane platform having a third side wall,
forming a fourth vane platform of the second vane assembly that extends circumferentially about the central axis radially spaced apart from the second vane platform and adjacent to the third vane platform, the second vane extending between and interconnecting the second and fourth vane platforms, the second and fourth vane platforms being radially outer and inner vane platforms of the second vane assembly, respectively, the fourth vane platform having a fourth side wall, and
forming a second spacer between the third and fourth vane platforms of the first and second vane assemblies, the second spacer extending between and interconnecting the third and fourth side walls.

6. The method of claim 5, further comprising
additively manufacturing a full hoop vane ring including a plurality of the engine assemblies each including the first and second vane assemblies and the first and second spacers formed therebetween.

7. The method of claim 6, further comprising
machining a plurality of surfaces of the plurality of the engine assemblies of the full hoop vane ring, and
after machining the pluralities of surfaces, removing each first and second spacer from the plurality of engine assemblies such that each first and second vane assembly arranged about the full hoop vane ring is spaced apart from each other so as to allow for thermal expansion and contraction of the first and second vane assemblies when arranged in and during operation of the gas turbine engine.

8. The method of claim 2, wherein the additive manufacturing of the first and second vane assemblies and the first spacer further includes forming a first seal between the first and second vane platforms of the first and second vane assemblies, the first seal configured to block the gases flowing over the first and second vane assemblies from passing through a gap between the first and second vane assemblies.

9. The method of claim 8, wherein the first seal is radially spaced apart from the first spacer in a direction toward the central axis.

10. The method of claim 9, wherein the additive manufacturing of the first and second vane assemblies and the first spacer further includes
forming a first groove having a first protrusion-receiving recess in the first side wall of the first vane platform,
forming a second groove having a second protrusion-receiving recess in the second side wall of the second vane platform, and
forming the first seal to include a first projecting portion received in the first protrusion-receiving recess and a second projecting portion received in the second protrusion-receiving recess such that the first seal is interlocked within the first and second grooves.

11. The method of claim 10, further comprising
removing the first spacer so as to allow the gases flowing over the first and second vane assemblies to interact with the first seal.

12. A method comprising
forming a first engine component of a gas turbine engine including a first side wall,
forming a second engine component of the gas turbine engine arranged adjacent to the first engine component and including a second side wall facing the first side wall,
forming a first spacer between the first and second engine components, the first spacer extending between and interconnecting the first and second side walls of the first and second engine components,
machining at least one surface of the first and second engine components so as to remove material from the at least one surface, and
after machining the at least one surface, removing the first spacer from between the first and second engine components.

13. The method of claim 12, wherein the first and second engine components and the first spacer are formed via additive manufacturing such that the first and second engine components and the first spacer are formed in a single fabrication operation.

14. The method of claim 13, wherein the first spacer is at least one of located so as be mechanically removable or formed of a material so as to chemically removable.

15. The method of claim 14, wherein the first engine component is a first vane assembly of the gas turbine engine and the second engine component is a second vane assembly, and wherein the first side wall is located on a first vane platform of the first vane assembly and the second side wall is located on a second vane platform of the second vane assembly.

16. The method of claim 15, further comprising
additively manufacturing a full hoop vane ring including a plurality of the first and second vane assemblies and a plurality of the first spacers formed therebetween.

17. The method of claim 16, wherein the additive manufacturing of the first and second vane assemblies and the first spacer further includes forming a first seal between the first and second vane platforms of the first and second vane assemblies, the first seal configured to block the gases flowing over the first and second vane assemblies from passing through a gap between the first and second vane assemblies, and wherein the first seal is radially spaced apart from the first spacer in a direction toward the central axis.

18. An engine component assembly for a gas turbine engine, the engine component assembly comprising
a first vane assembly of a gas turbine engine including a first vane platform that extends circumferentially about a central axis of the gas turbine engine and a first vane extending radially away from the first vane platform and configured to interact with gases flowing through the gas turbine engine, the first vane platform having a first side wall,
a second vane assembly arranged adjacent to the first vane assembly and including a second vane platform that extends circumferentially about the and a second vane extending radially away from the second vane platform and configured to interact with gases flowing through the gas turbine engine, the second vane platform having a second side wall, and
a first spacer arranged between the first and second vane platforms of the first and second vane assemblies, the first spacer extending between and interconnecting the first and second side walls,
wherein the first and second engine vane assemblies and the first spacer are formed via additive manufacturing such that the first and second vane assemblies and the first spacer are formed in a single fabrication operation, wherein the first spacer provides structural support for the engine component assembly at least during the additive manufacturing of the first and second vane assemblies and during post-processing machining of the first and second vane assemblies after the additive manufacturing.

19. The engine component assembly of claim 18, wherein the first spacer is removable such that the first spacer is configured to be removed from the first and second vane assemblies after the additive manufacturing of the first and second vane assemblies, wherein the first spacer is at least one of located so as be mechanically removable or formed of a material so as to chemically removable, and wherein the first and second vane assemblies are machinable such that material is configured to be removed from at least one surface of the first and second vane assemblies, and wherein the first spacer is removable after machining of the at least one surface occurs.

20. The engine component assembly of claim 19, further comprising
a first seal arranged between the first and second vane platforms of the first and second vane assemblies, the first seal configured to block the gases flowing over the first and second vane assemblies from passing through a gap between the first and second vane assemblies, and wherein the first seal is radially spaced apart from the first spacer in a direction toward the central axis.
